(19) United States
(12) Patent Application Publication
(10) Pub. No.: US 2025/0262529 A1
(43) Pub. Date: Aug. 21, 2025

(54) VIRTUAL REALITY ACCESSORY

(71) Applicant: Brandon Joseph Allen, Cary, NC (US)

(72) Inventor: Brandon Joseph Allen, Cary, NC (US)

(21) Appl. No.: 19/053,980

(22) Filed: Feb. 14, 2025

Related U.S. Application Data
(60) Provisional application No. 63/553,750, filed on Feb. 15, 2024.

(51) Int. Cl. A63F 13/245

(52) U.S. Cl. CPC A63F 13/245; A63F 2300/8082

(57) ABSTRACT

A device for simulating a weapon in a virtual reality (VR) environment, an augmented reality (AR) environment, a mixed reality (MR) environment, and/or combinations thereof. The device is adjustable to fit a user's shape and receive a gaming controller. The device includes a forearm grip and a front-end grip that improves the simulation of weaponry and user immersion.

### CROSS-REFERENCE TO RELATED APPLICATIONS

This application is related to and claims priority to U.S. provisional patent application No. 63/553,750, filed on Feb. 15, 2024, the entire contents of which is incorporated by reference herein in its entirety.

### BACKGROUND

Virtual reality (VR) is an interactive simulation of a three-dimensional image or environment. Typically, headsets with screens in combination with controllers are used to create a VR experience. Users can experience sickness from VR experience because of a mismatch between movement in the VR environment and expected movement by an eye of a user. VR sickness can also be a result of postural instability.

### TECHNICAL FIELD

The present disclosure is generally directed to virtual reality (VR) accessories, more specifically to virtual reality gaming accessories for simulating weapons.

### DESCRIPTION OF RELATED ART

VR systems can include headsets, gloves, foot platforms, and other similar accessories for simulating the VR environment. Current VR accessories struggle to simulate an object (e.g., weapon) corresponding to a VR environment and can cause or increase user sickness. These VR accessories have a limited range of motion. For example, some VR accessories have grips that create collisions when a user is simulating various firearms in virtual reality. As a result, the immersion of the VR environment is ruined by the limited functionality of the current VR accessories. Therefore, there is a need for a VR accessory that improves user VR experience by improving the simulation of weapons in a VR environment.

### BRIEF SUMMARY

In some embodiments, a virtual reality (VR) accessory for simulating a weapon in a virtual reality environment is disclosed. The VR accessory includes a grip, a sleeve, a stock beam, a double joint connector, an adjustable connector, a butt pad, a cheek weld height adjustment component, a cheek weld, a hub, a mounting gear and angle adjustment, a forearm brace mounting sleeve, a forearm brace, a mounting point for a front grip, and/or a strap adapter for receiving a controller.

In some embodiments, a virtual reality (VR) accessory for simulating a weapon in a virtual reality environment is disclosed. The VR accessory includes a grip, a sleeve, a stock beam, a double joint connector, an adjustable connector, a butt pad, a cheek weld height adjustment component, a cheek weld, a hub, a mounting point for front-end grip accessories, a pistol paddle, an adjustment sleeve for a front-end grip, and/or a front-end grip.

In some embodiments, a virtual reality (VR) accessory for simulating a weapon in a virtual reality environment is disclosed. The VR accessory includes a grip, a sleeve, a stock beam, a double joint connector, an adjustable connector, a butt pad, a cheek weld height adjustment component, a cheek weld, a hub, a mounting point for grip accessories, a pistol paddle, an adjustment sleeve for a front-end grip, a front-end grip, and/or a forearm brace.

In at least one embodiment of the present disclosure, a device for simulating a weapon is disclosed. The device can include a brace, a brace sleeve, an adjustment mechanism, a grip, a hub, a support beam member, a support beam member sleeve, a double jointed connector, and/or an adjustable connector. The brace can be adjustably connected to the brace sleeve. The can be adjustably connected to the adjustment mechanism. The adjustment mechanism can be connected to the hub. The hub can be connected to the brace, support beam member, and/or the grip. The grip can receive at least a portion of a gaming controller. The support beam member can be adjustably connected to the support beam member sleeve. The support beam member can be connected to the double jointed connector. The double jointed connected can be connected to the adjustable buttstock.

The device can be used in virtual reality, augmented reality, mixed reality, and/or combinations thereof. The device may include an adjustable buttstock including an adjustable height component and a cheek weld. The adjustable height component can raise and lower the cheek weld. The adjustment mechanism may be designed for lateral and vertical angle adjustment of the brace. The hub can connect to the grip at about midway of a height of the grip. The double jointed connector can enable lateral movement of the adjustable buttstock. The device may further include an adjustable connector positioned between the double jointed connector and the adjustable buttstock. The adjustable connector can be designed to adjust a tilt position of the adjustable buttstock. The brace sleeve may lengthen or shorten the brace. The support beam member sleeve can lengthen or shorten the support beam member. The device may further include a controller handle including at least two magnets and a grip including at least two magnets and at least one slot. The grip can receive the controller handle using the at least two magnets and the at least one slot.

In at least one embodiment of the present disclosure, a device for simulating a weapon is disclosed. The device may include a front-end grip, a front-end grip sleeve, an adjustment mechanism, a grip, a hub, a support beam member, a support beam member sleeve, a double jointed connector, and an adjustable buttstock. The front-end grip can be adjustably connected to the front-end grip sleeve. The front-end grip may be adjustably connected to a mounting point on the grip. The hub can be connected to the support beam member and the grip. The grip can receive at least a portion of a gaming controller. The support beam member can be adjustably connected to the support beam member sleeve. The support beam member can be connected to the double jointed connector. The double jointed connector may be connected to the adjustable buttstock.

The device may be used in virtual reality, augmented reality, mixed reality, and/or combinations thereof. The mounting point may be positioned about midway of a height of the grip. The front-end grip sleeve can lengthen and/or shorten the front-end grip. The support beam member can lengthen or shorten the support beam member. The device may further include a controller handle. The controller handle can include at least two magnets. The grip may include at least two magnets and at least one slot. The grip can receive the controller handle via the at least two magnets and the at least one slot. The grip may include a concave shape. The device may further include a paddle that is adjustably connected to the grip. The device may further include an adjustable connector positioned between the double jointed connector and the adjustable buttstock. The adjustable connector can change a tilt position of the adjustable buttstock. The hub may receive a brace that is removably connected to the hub.

### BRIEF DESCRIPTION OF THE SEVERAL VIEWS OF THE DRAWINGS

The embodiments illustrated, described, and discussed herein are illustrative of the present disclosure. As these embodiments of the present disclosure are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1 illustrates a side perspective view of VR accessory including a forearm brace according to an embodiment of the present disclosure.

FIG. 2 illustrates a rear perspective view of VR accessory including a forearm brace according to an embodiment of the present disclosure.

FIG. 3 illustrates a side perspective view of VR accessory including a forearm brace according to an embodiment of the present disclosure.

FIG. 4 illustrates a top perspective view of a front of a VR accessory including a forearm brace according to an embodiment of the present disclosure.

FIG. 5 illustrates a front perspective view of a VR accessory including a forearm brace according to an embodiment of the present disclosure.

FIG. 6 illustrates a side perspective view of a VR accessory including a forearm brace according to an embodiment of the present disclosure.

FIG. 7 illustrates a side perspective view of a VR accessory including a forearm brace according to an embodiment of the present disclosure.

FIG. 8 illustrates a top perspective view of a VR accessory including a forearm brace according to an embodiment of the present disclosure.

FIG. 9 illustrates a bottom view of a VR accessory including a forearm brace according to an embodiment of the present disclosure.

FIG. 10 illustrates a side view of a VR accessory without a forearm brace according to an embodiment of the present disclosure.

FIG. 11 illustrates a front view of a VR accessory without a forearm brace according to an embodiment of the present disclosure.

FIG. 12 illustrates a front view of a VR accessory including a front-end grip according to an embodiment of the present disclosure.

FIG. 13 illustrates a front view of a VR accessory including a front-end grip according to an embodiment of the present disclosure.

FIG. 14 illustrates a rear view of a VR accessory including a front-end grip according to an embodiment of the present disclosure.

FIG. 15 illustrates a bottom view of a VR accessory including a front-end grip according to an embodiment of the present disclosure.

FIG. 16 illustrates a top perspective view of a VR accessory including a front-end grip and a forearm brace according to an embodiment of the present disclosure.

FIG. 17 illustrates a top perspective view of a VR accessory including a front-end grip and a forearm brace according to an embodiment of the present disclosure.

FIG. 18 illustrates a component view of a VR accessory including a front-end grip and a forearm brace according to an embodiment of the present disclosure.

FIG. 19 illustrates a side perspective view of a VR accessory including a forearm grip and a detached front-end grip according to an embodiment of the present disclosure.

FIG. 20 illustrates a side view of a grip attachment of a VR accessory according to one an embodiment of the present disclosure.

FIG. 21 illustrates an interior view of a grip attachment of a VR accessory according to an embodiment of the present disclosure.

FIG. 22 illustrates a side view of a grip attachment of a VR accessory according to an embodiment of the present disclosure.

FIG. 23 illustrates a side view of a grip of a grip attachment VR accessory according to an embodiment of the present disclosure.

### DETAILED DESCRIPTION

For the purposes of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

Aspects of the present disclosure are related to a device for simulating equipment in a VR environment, an augmented reality (AR) environment, a mixed reality (MR) environment, hybrid reality, or a combination and/or derivatives thereof. The device may be used to simulate holding a weapon. The device can be customizable to improve the comfort of a user, thereby improving the immersion of the simulated environment.

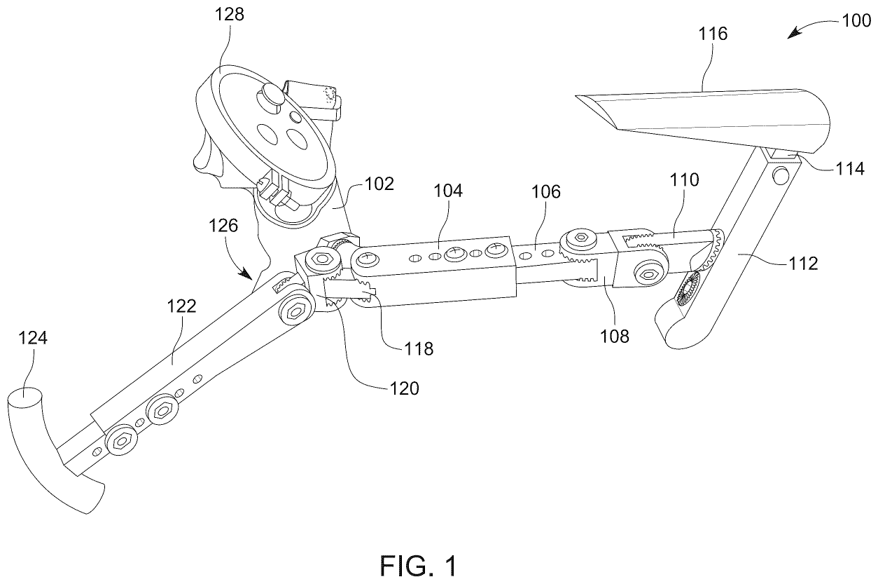

FIG. 1 illustrates a VR accessory 100 according to an embodiment of the present disclosure. The VR accessory 100 includes a grip 102, a sleeve 104, a stock beam 106, a double joint connector 108, an adjustable connector 110, a butt pad 112, a cheek weld height adjustment component 114, a cheek weld 116, a hub 118, a mounting gear and angle adjustment 120, a forearm brace mounting sleeve 122, a forearm brace 124, a mounting point 126 for a front grip, and a strap adapter 128 for receiving a controller.

The grip 102 is operable to receive at least a portion of a gaming controller (e.g., VR controller, Meta Quest 3). For example, and without limitation, the grip receives at least a portion of a VR controller in an interior of a body of the grip. The grip 102 includes a mounting point to receive a stock/buttstock portion of the forearm brace 124. The grip may be of varying designs to receive controllers with different contours and sizes. The mounting point is positioned about midway up the grip 102. Advantageously this creates an empty physical space at the bottom and top of the stock beam 106 to increase the freedom of movement for a user when reloading virtual reality weapons (e.g., pistols with handle-mounted magwells or bullups). Yet another advantage of the VR accessory 100 includes enabling unrestricted wrist movement that simplifies and increases the speed of transitioning to fully aiming down the sights in a corresponding VR environment.

The main sleeve 104 includes a female connector that allows for length adjustments. The sleeve may include connectors of varied sizes and designs for facilitating length adjustments. The length adjustments allow for the VR accessory 100 to maximize user comfort and stability while aiming. The front portion of the sleeve 104 includes a geared connection that enables angle adjustments in the lateral plane. The angle adjustments enable a wearer to adjust the brace for maximum comfort and stability (e.g., posture). In some embodiments, the main sleeve includes a friction joint or a ball joint that support the angle adjustments. In some other embodiments, the sleeve includes a spring-loaded mechanism or other quick release mechanism to increase adjustment speed.

The beam 106 is adjustably connected to the main sleeve. The beam 106 includes a male connector that is attachable to the female connector of the main sleeve 104. The beam 106 is connected to the double joint connector 108 via a flat gear connection. The beam 106 can be a tubular shape, a rectangular shape, and other similar shapes. The beam 106 can include aluminum, carbon fiber, and/or other similar materials. In some embodiments, the beam includes a linear gear and a quick release mechanism (e.g., spring loaded locking mechanism).

The double joint connector 108 enables adjustments of the VR accessory to align the butt pad 112 with a user's shoulder. In some embodiments, the double connector 108 includes a plurality of gears. The plurality of gears enables angle adjustments of the VR accessory. Alternatively, or additionally, the double joint connector includes a ball and socket joint.

The small adjustment connector 110 is operable for controlling the tilting of the butt rest. The small adjustment connector 110 includes a gear mechanism for forward and/or backward tilting of the butt rest. In some embodiments, the small adjustment connector includes a friction-fit connection point. Alternatively, a spring-loaded bolt or a quick release mechanism may be used.

The butt pad 112 includes a supportive surface for providing comfort when resting against a user. The cheek weld 116 is connected to the butt pad 112 via the cheek weld height adjustment component 114. The cheek weld height adjustment component 114 includes a slotted connection and at least one bolt. The at least one bolt is removable, which enables the height of the cheek weld to be adjusted. In some embodiments, the cheek weld adjustment component includes a telescopic component. The cheek weld adjustment component can include a linear gear mechanism. In some embodiments, the VR accessory is designed for customization or tailoring of the position of the butt pad and/or cheek weld to fit a user. The VR accessory can include connections, fasteners, and other attachment systems designed for improving the positioning of the VR accessory relative to a user. Advantageously, this increases the comfort of a user during operation of the VR accessory, reduces user sickness, improves the operability, and increases the realistic feel of the VR accessory.

The cheek weld 116 includes an angled shape that allows a user to position their face against the cheek weld when aiming a simulated firearm in a VR environment. The cheek weld 116 is connected to an adjustable flat gear connection. The gear connection can be frictionally held by the cheek weld adjustment component 114. The cheek weld may include a quick release skewer, a spring-loaded mechanism, a clamp mechanism, and other mechanisms for facilitating the repositioning of the cheek weld.

The main hub 118 includes a plurality of geared surfaces. The plurality of geared surfaces provides an adjustable mounting point that enables the grip to connect to the forearm brace 124 and/or the gunstock. The main hub 118, at the point where the main sleeve 104 connects to the main hub 118, includes a rear portion including a male connector for a gear adjustment and/or mounting point. The main hub further includes another male connector for receiving off-hand stability accessories (e.g., forearm brace 124) or knubs for hand weapons.

The mounting gear and angle adjustment mechanism 120 enables the lateral and vertical angle adjustment of the forearm brace 124 to maximize comfort and stability. In some embodiments, the mounting gear and adjustment mechanism can include a ball joint. The mounting gear and angle adjustment mechanism may include wing nuts, quick release skewers, and/or spring-loaded mechanism.

The forearm brace mounting sleeve 122 includes a sleeve receiver including an angle adjustment gear and a slot to receive an outer portion of the forearm brace 124. The forearm brace mounting sleeve 122 enables the lengthening and shortening of the forearm brace 124. The forearm brace mounting sleeve 122 can be frictionally attached to the mounting gear and adjustment mechanism 120. In some embodiments, the forearm brace mounting sleeve 122 can include a clamping apparatus and/or an adjustment gear.

The forearm brace 124 includes a curved shape and is connected to the forearm brace mounting sleeve 122 via a connection bar or beam. The forearm brace 124 is secured by a plurality of fasteners to stabilize the VR accessory 100. The forearm brace 124 removes the need for a user to physically grab an object with the user's offhand. The forearm brace includes an end that may be an oblong spherical shape, a magnetic ball joint, or a concave shape. The forearm brace 124 further includes an offset angle that enables the VR accessory to keep a physical space in front of the grip free of obstruction. As a result, users can experience increased movement freedom when reloading rifles in a VR environment. Another advantage of the forearm brace 124 includes enabling a user free to handle a VR weapon without physical restrictions and supports two handed stability.

The VR accessory 100 further includes a mounting point 126 for front-end grip accessories. The mounting point 126 includes a plurality of holes for affixing a gear connection in front of the grip 102. The VR accessory 100 further includes a ring strap adapter 128 including a hook and loop mechanism for receiving a users' wrist.

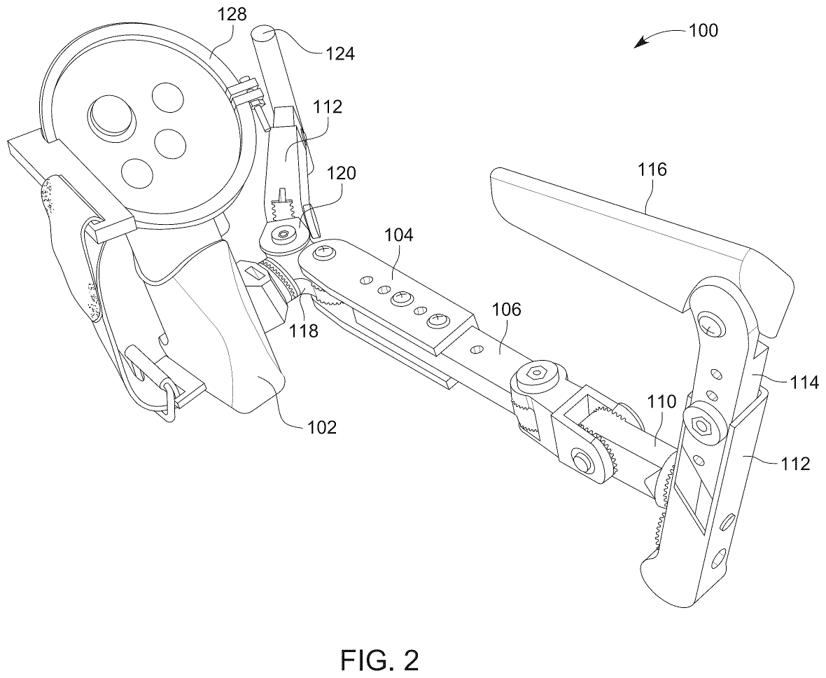

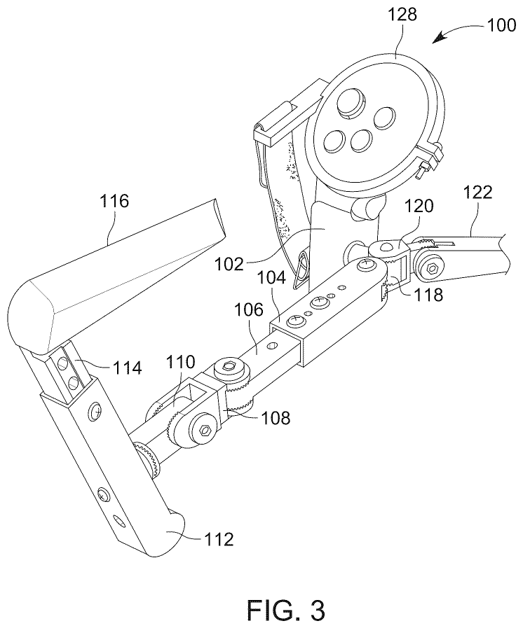

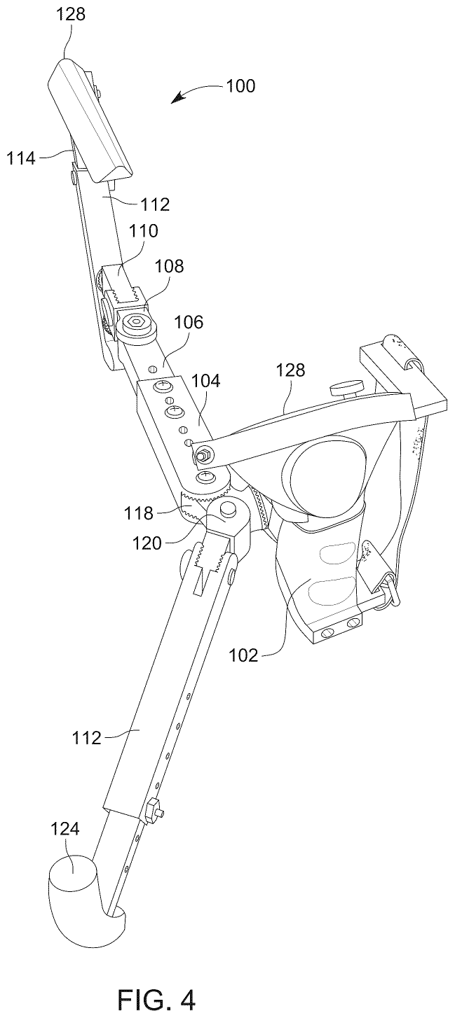

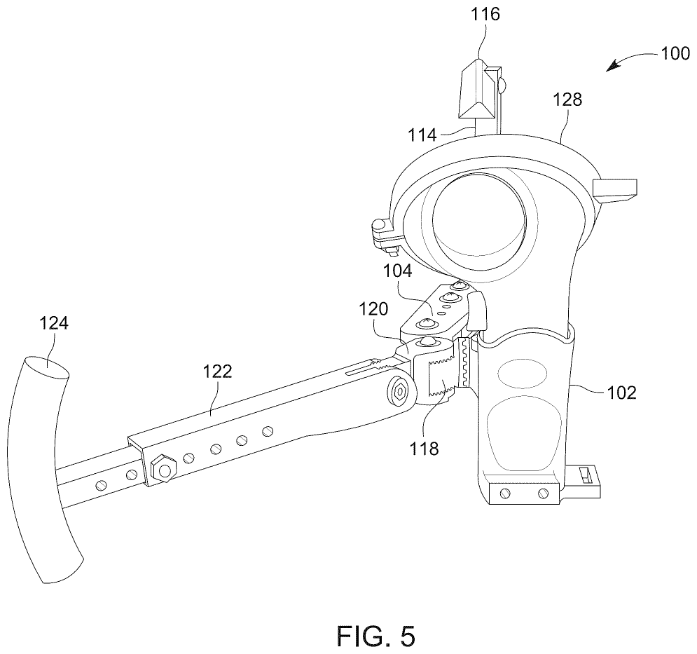

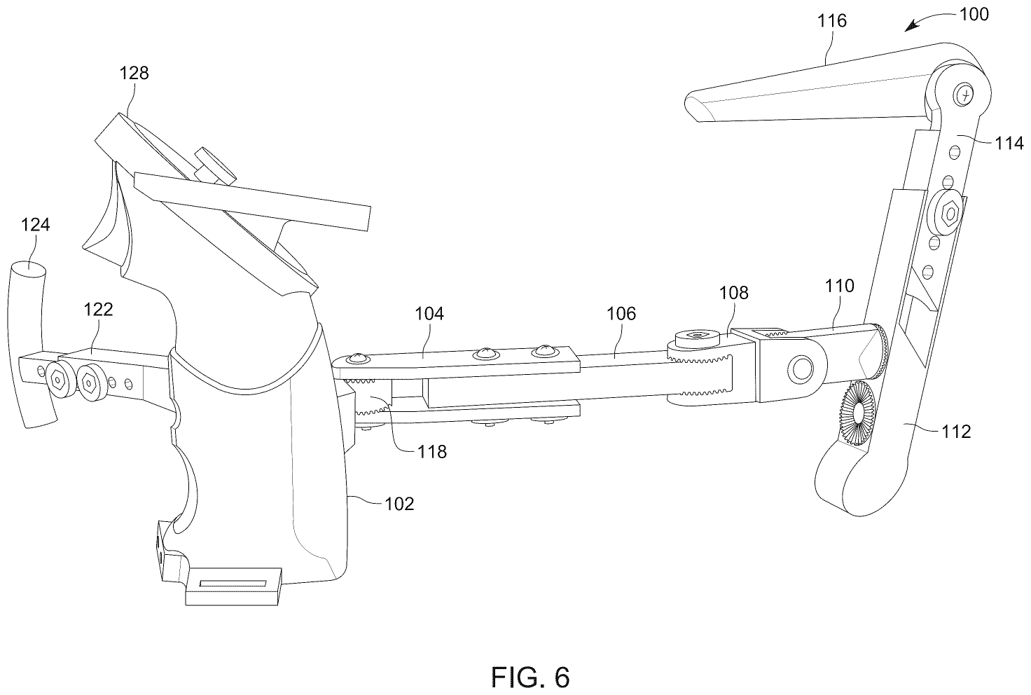

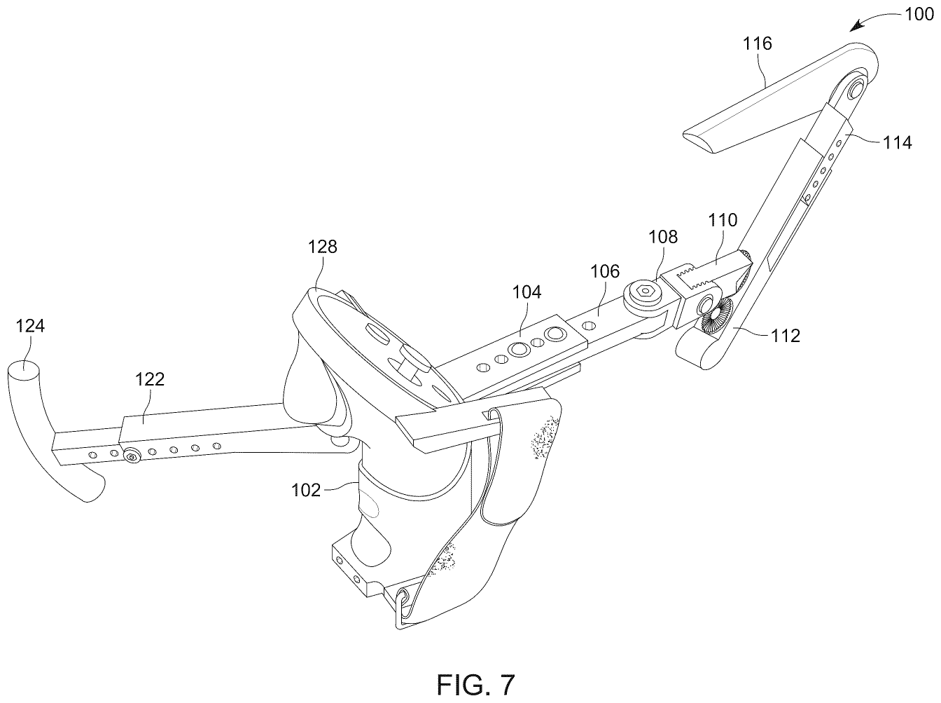

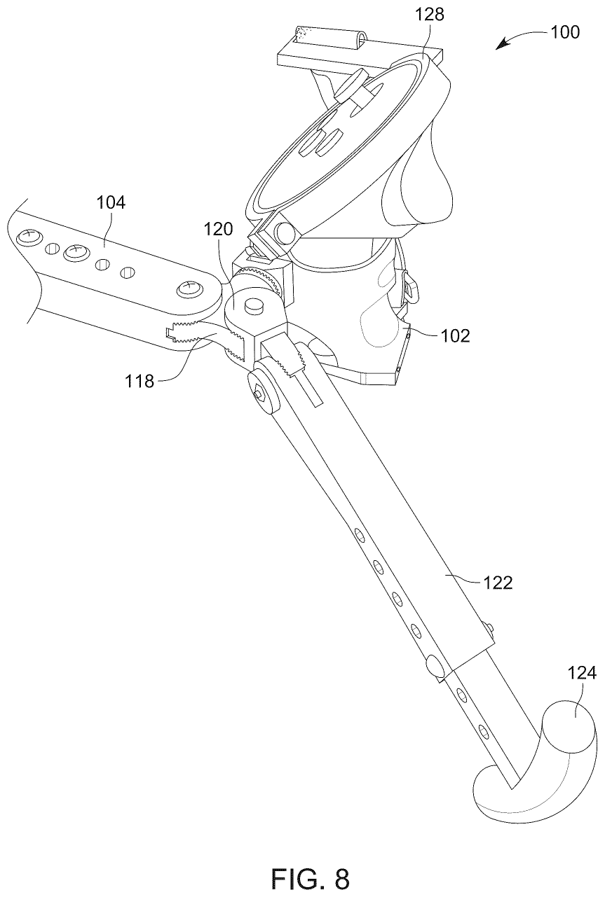

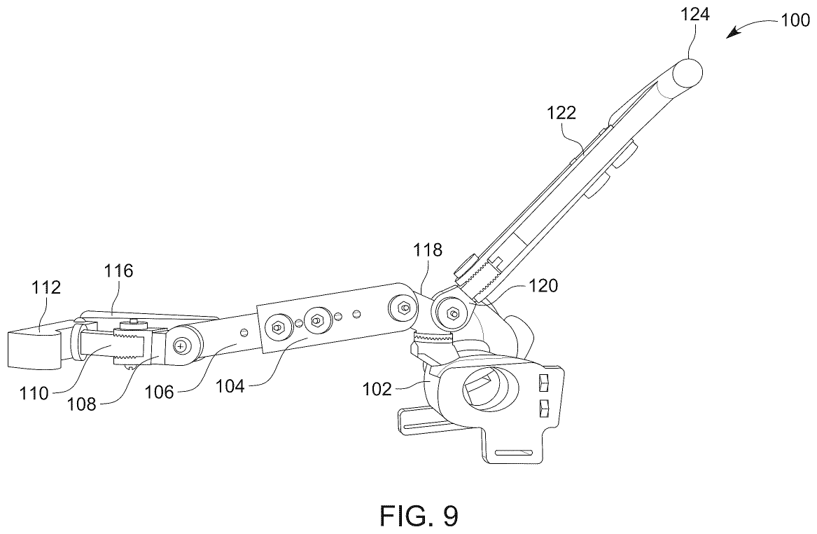

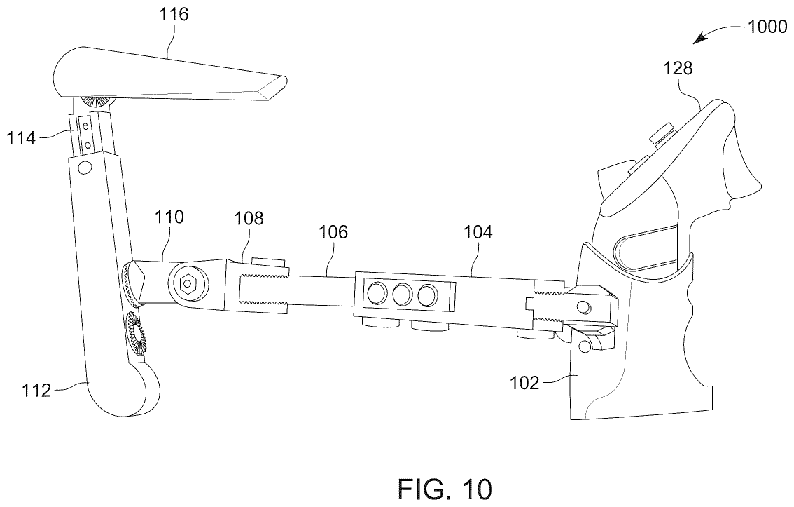

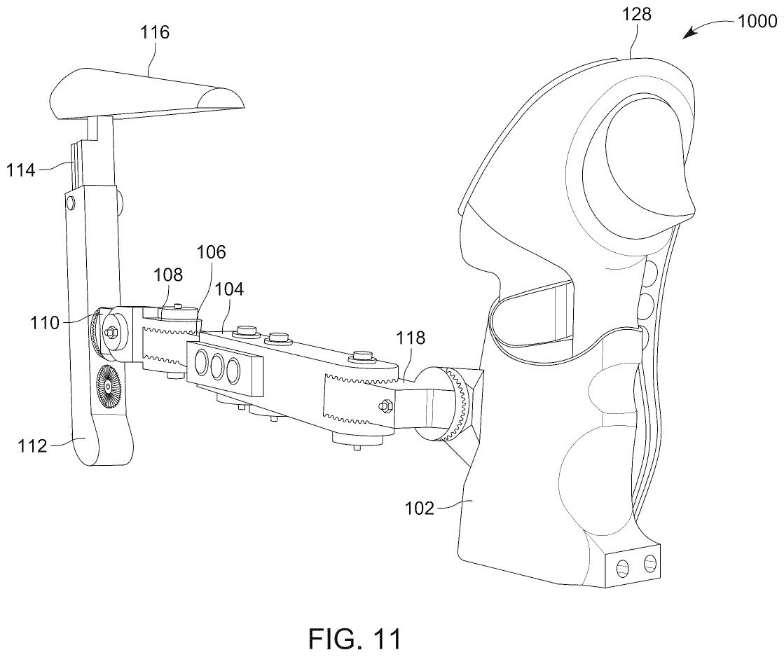

FIG. 2 illustrates a rear perspective view of VR accessory including a forearm brace according to an embodiment of the present disclosure. FIG. 3 illustrates a side perspective view of VR accessory including a forearm brace according to an embodiment of the present disclosure. FIG. 4 illustrates a top perspective view of a front of a VR accessory including a forearm brace according to an embodiment of the present disclosure. FIG. 5 illustrates a front perspective view of a VR accessory including a forearm brace according to an embodiment of the present disclosure. FIG. 6 illustrates a side perspective view of a VR accessory including a forearm brace according to an embodiment of the present disclosure. FIG. 7 illustrates a side perspective view of a VR accessory including a forearm brace according to an embodiment of the present disclosure. FIG. 8 illustrates a top perspective view of a VR accessory including a forearm brace according to an embodiment of the present disclosure. FIG. 9 illustrates a bottom view of a VR accessory including a forearm brace according to an embodiment of the present disclosure. FIG. 10 illustrates a side view of a VR accessory without a forearm brace according to an embodiment of the present disclosure. FIG. 11 illustrates a front view of a VR accessory without a forearm brace according to an embodiment of the present disclosure.

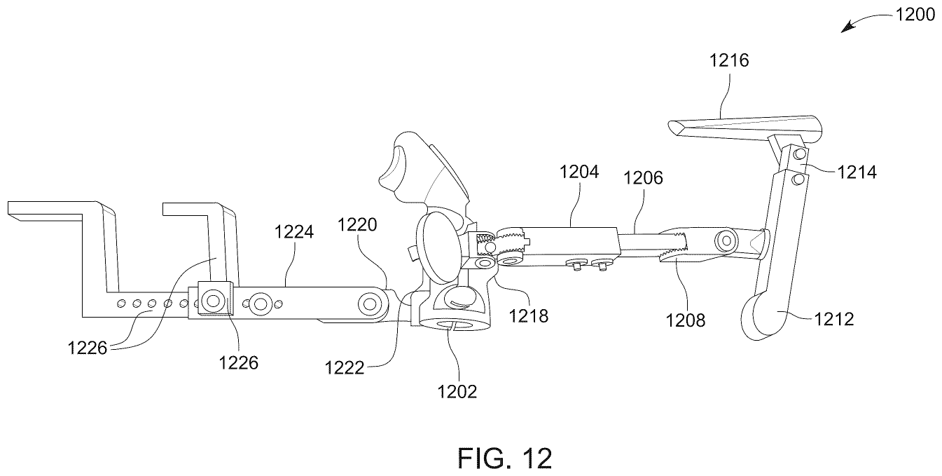

FIG. 12 illustrates a side perspective of a VR accessory 1200 according to an embodiment of the present disclosure. The VR accessory 1200 includes a grip 1202, a sleeve 1204, a beam 1206, a double joint connector 1208, an adjustable connector 1210, a butt pad 1212, a cheek weld height adjustment component 1214, a cheek weld 1216, a hub 1218, a mounting point 1220 for front-end grip accessories, a pistol paddle 1222, an adjustment sleeve 1224 for a front-end grip, and a front-end grip 1226.

The grip 1202 is operable to receive at least a portion of a gaming controller (e.g., VR controller, Meta Quest 3). For example, and without limitation, the grip receives at least a portion of a VR controller in an interior of a body of the grip. The grip may be of varying designs to receive controllers with different contours and sizes. The grip 1202 includes a mounting point to receive a stock/buttstock portion of the front-end grip 1226. The mounting point is positioned about midway up the grip 1202. Advantageously this creates an empty physical space at the bottom and top of the stock beam 1206 to increase the freedom of movement for a user when reloading virtual reality weapons (e.g., pistols with handle-mounted magwells or bullups). Another advantage of the VR accessory 1200 includes enabling unrestricted wrist movement which simplifies and increases the speed of transitioning to fully aiming down the sights in a corresponding VR environment.

The main sleeve 1204 includes a female connector that allows for length adjustment. The sleeve may include connectors of varied sizes and designs for facilitating length adjustments. Advantageously, the length adjustments of the VR accessory 1200 maximize user comfort and stability while aiming because a user can adjust VR accessory to fit their body shape. The front portion of the sleeve 1204 includes a geared connection that enables angle adjustments in the lateral plane. The angle adjustments enable a wearer to adjust the brace for maximum comfort and stability (e.g., posture). In some embodiments, the main sleeve includes a friction joint or a ball joint that enable the angle adjustments. In some other embodiments, the sleeve includes a spring-loaded mechanism or other quick release mechanism to increase adjustment speed.

The beam 1206 is adjustably connected to the main sleeve. The beam 1206 includes a male connector that is attachable to the female connector of the main sleeve 1204. The beam 1206 includes a flat gear in connection to the double joint connector 1208. The beam 1206 can be a tubular shape, a rectangular shape, and other similar shapes. The beam 1206 can include aluminum, carbon fiber, and/or other similar materials. In some embodiments, the beam includes a linear gear and a quick release mechanism (e.g., spring loaded locking mechanism).

The double joint connector 1208 enables adjustments of the VR accessory 1200 to align the butt pad 1212 with a user's shoulder. In some embodiments, the double joint connector 1208 includes a plurality of gears. The plurality of gears enables angle adjustments of the VR accessory 1200. Alternatively, or additionally, the double joint connector includes a ball and socket joint.

The small adjustment connector 1210 is operable for controlling the tilting of the butt rest. The small adjustment connector 1210 includes a gear designed for forward and/or backward tilting of the butt rest. In some embodiments, the small adjustment connector includes a friction-fit connection point. In some other embodiments, the small adjustment connector can include a spring-loaded bolt or a quick release mechanism. In some embodiments, the small adjustment connector 1210 can include mechanisms (e.g., fasteners) that enable the tilt adjustment of the butt rest to customize the VR accessory to user preference and comfort.

The butt pad 1212 includes a supportive surface for providing comfort when resting against a user. The cheek weld 1216 is connected to the butt pad 1212 via the cheek weld height adjustment component 1214. The cheek weld height adjustment component 1214 includes a slotted connection and at least one bolt. The at least one bolt is removable, which enables the positioning of the cheek weld to be adjusted. In some embodiments, the cheek weld adjustment component includes a telescopic component. The cheek weld adjustment component can include a linear gear mechanism. In some embodiments, the VR accessory is designed for customization or tailoring of the position of the butt pad and/or cheek weld to fit a user. The VR accessory can include connections, fasteners, and other attachment systems designed for improving the positioning of the VR accessory relative to a user. Advantageously, this increases the comfort of a user during operation of the VR accessory, reduces user sickness, improves the operability, and increases the realistic feel of the VR accessory.

The cheek weld 1216 includes an angled shape that allows a user to position their face against the cheek weld when aiming a simulated firearm in a VR environment. The cheek weld 1216 is connected to an adjustable flat gear connection. The adjustable flat gear connection can be frictionally held by the cheek weld adjustment component 1214. The cheek weld may include a quick release skewer, a spring-loaded mechanism, a clamp mechanism, and other mechanisms for facilitating the repositioning of the cheek weld.

The main hub 1218 includes a plurality of geared surfaces. The plurality of geared surfaces provides an adjustable mounting point that enables the grip to be connected to the front-end grip 1226 and/or the gunstock. The main hub 1218, at the point where the main sleeve 1204 connects to the main hub 1218, includes a rear portion including a male connector for a gear adjustment and/or mounting point. The main hub further includes another male connector for receiving off-hand stability accessories (e.g., front-end grip 1226) or knubs for hand weapons.

The VR accessory 1200 can further include a mounting point 1220 for front-end grip accessories. The mounting point 1220 includes a plurality of holes for affixing a gear connection in front of the grip 1202. The VR accessory 1200 may further include a ring strap adapter including a hook and loop mechanism for receiving a users' wrist.

The pistol paddle 1222 enables VR users to wield virtual pistols and other similar VR weapons when both hands wield a weapon.

The adjustment sleeve 1224 includes an angle adjustment gear and a slot to receive an outer portion of the front-end grip 1226. The adjustment sleeve 1224 enables the lengthening and shortening of the front-end grip 1226. The adjustment sleeve 1224 can be frictionally attached to the mounting point 1220. The adjustment sleeve 1224 can include a clamping apparatus and/or an adjustment gear.

The front-end grip 1226 includes an angled handle for receiving a user's hand. In some embodiments, the front-end grip includes a concave shape to match a handle of a VR controller.

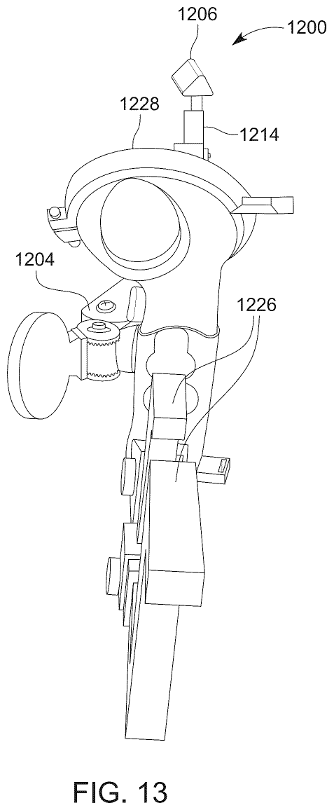

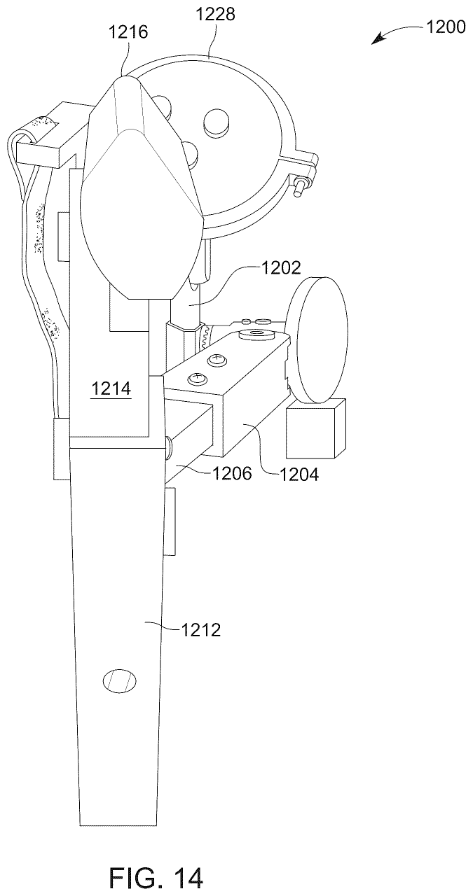

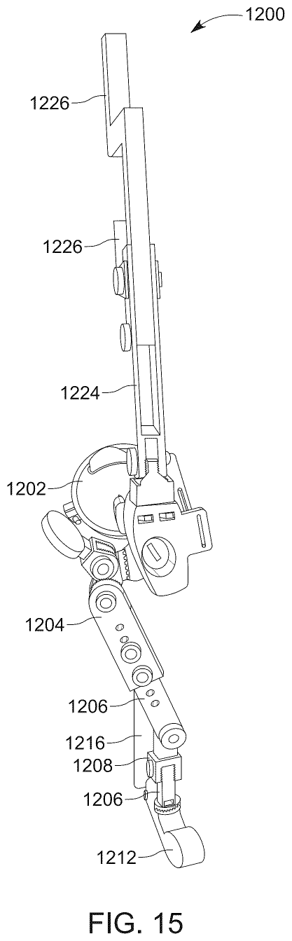

FIG. 13 illustrates a front view of a VR accessory including a front-end grip according to an embodiment of the present disclosure. FIG. 14 illustrates a rear view of a VR accessory including a front-end grip according to an embodiment of the present disclosure. FIG. 15 illustrates a bottom view of a VR accessory including a front-end grip according to an embodiment of the present disclosure.

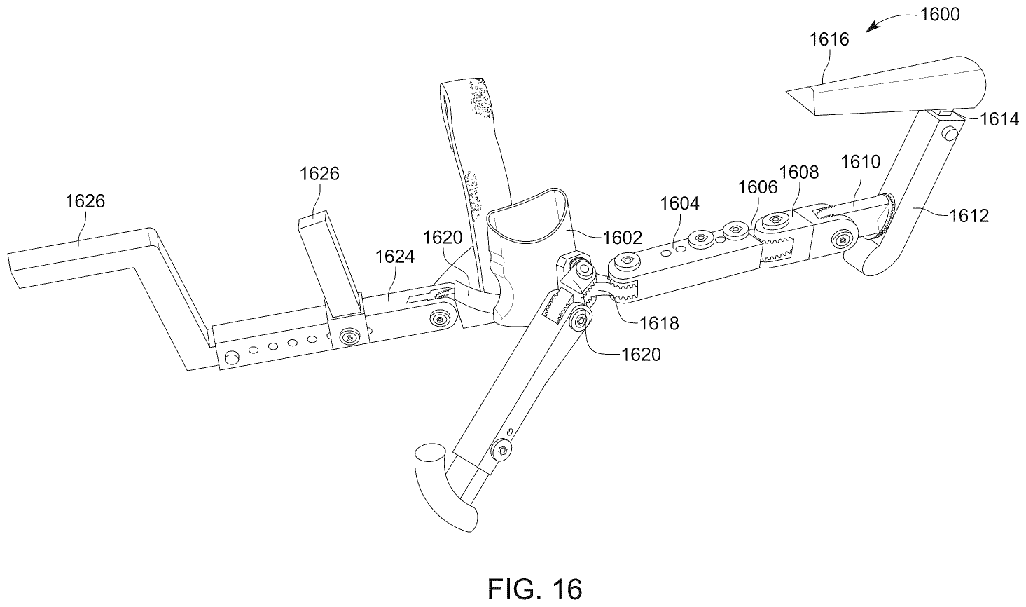

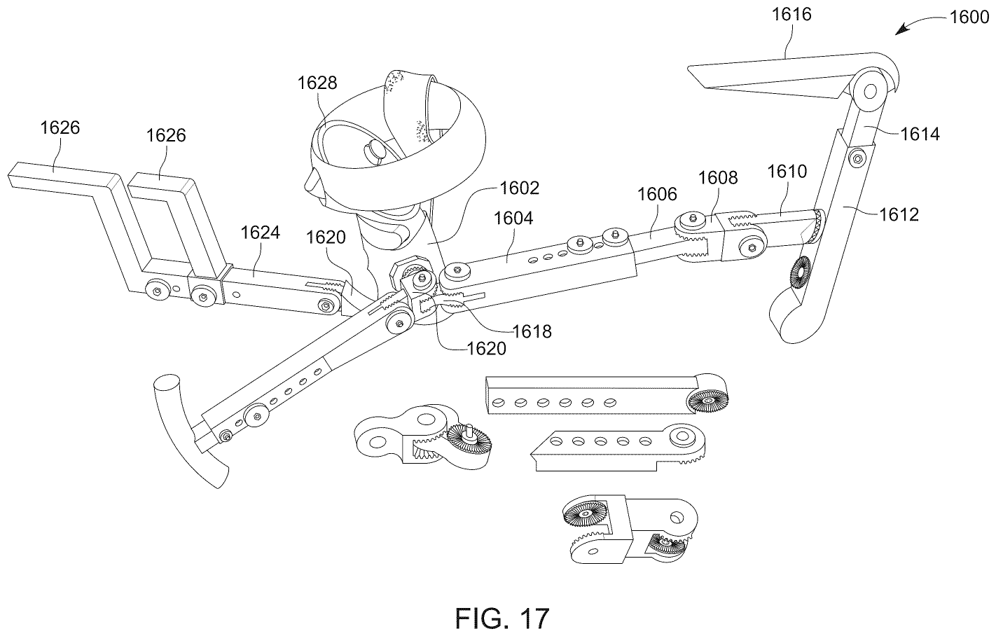

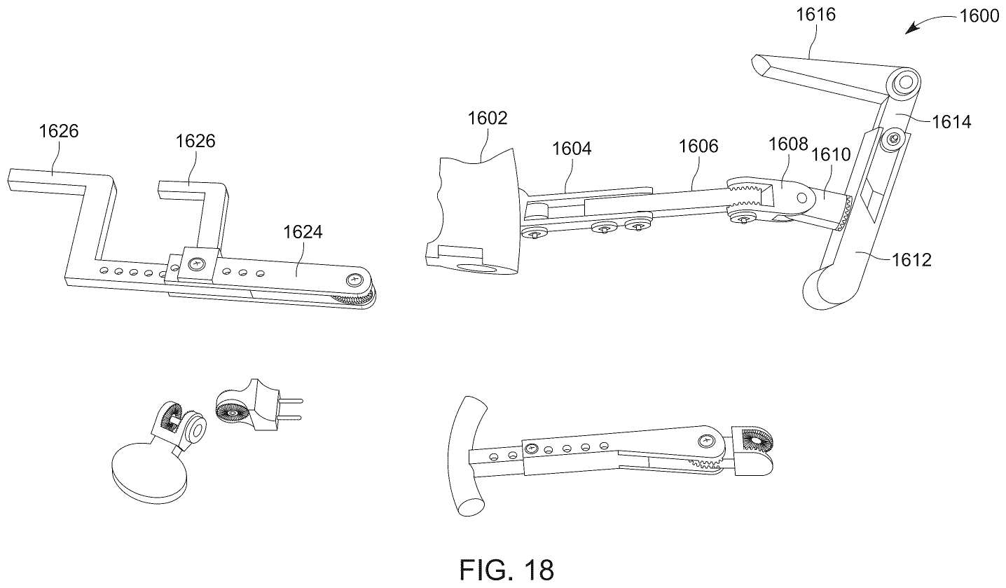

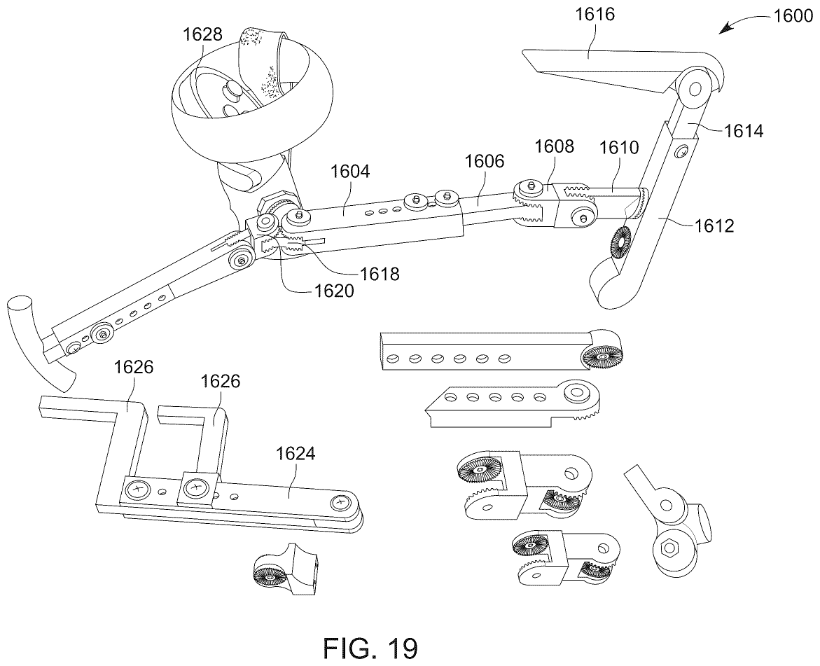

FIG. 16 illustrates a top perspective view of a VR accessory including a front-end grip and a forearm brace according to an embodiment of the present disclosure. For example, and without limitation, the VR accessory includes a front-end grip and forearm brace as shown and described in FIGS. 1-9 and FIGS. 12-15. FIG. 17 illustrates a top perspective view of a VR accessory including a front-end grip and a forearm brace according to an embodiment of the present disclosure. FIG. 18 illustrates a component view of a VR accessory including a front-end grip and a forearm brace according to an embodiment of the present disclosure. FIG. 19 illustrates a side perspective view of a VR accessory including a forearm grip and a detached front-end grip according to an embodiment of the present disclosure.

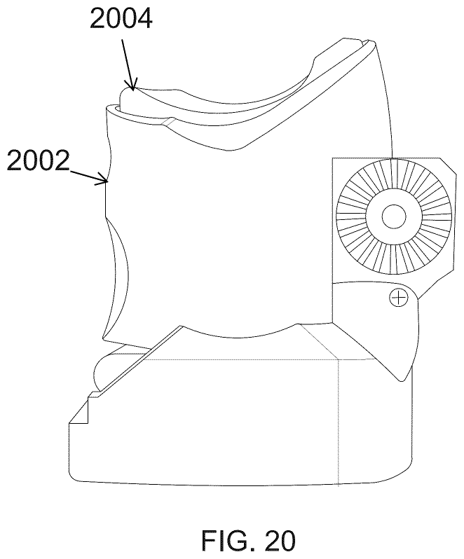

FIG. 20 illustrates a side view of a magnetic handle and receiver of a grip of a VR accessory according to an embodiment of the present disclosure. In some embodiments, the magnetic receiver 2004 can nestle in the magnetic receiver 2002. In some embodiments, the grip includes at least one magnet and at least one groove. The magnetic handle includes at least one magnet. The magnetic handle is operable to receive a gaming controller (e.g., VR controller). For example, and without limitation, the virtual reality controller can include a Quest 2 controller, Quest 3 controller, or a Quest Pro controller. The handle is designed to slide into the grip. When sliding into the grip, a portion of the handle slides into the at least one slot to create a mechanical connection. Additionally, the at least one magnet on the bottom of the handle attaches to one or more magnets positioned on the grip of the VR accessory. Advantageously, the magnetic and mechanical connections increase the attachment and stability of the VR grip handle and grip, thereby making it harder to accidentally remove the handle while in a VR environment.

In some embodiments, the grip includes at least one spacer (e.g., bump, extension) for preventing contact between a controller and an interior of the grip. The spacer may include any material or design for reducing collusions between the controller grip body and the grip of the accessory. Advantageously, this prevents damage to a surface of the controller and noise caused by contact between the controller and the grip.

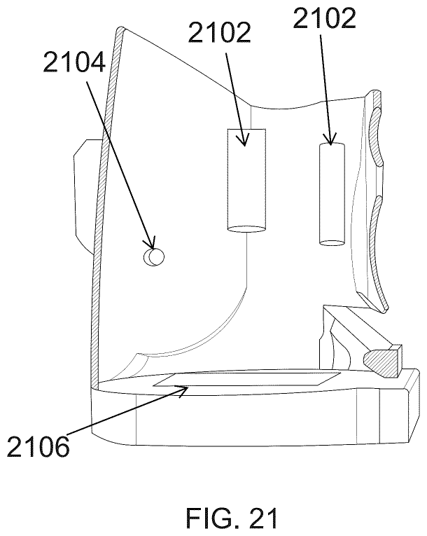

FIG. 21 illustrates a side view of a magnetic grip receiver of a VR accessory according to an embodiment of the present disclosure. In some embodiments, the magnetic grip receiver includes at least one spacer 2102, at least one hole 2104, and at least one magnet 2106. In some embodiments, as shown in FIG. 21, the at least one hole allows for the transmission of light. For example, and without limitation, some gaming controllers utilize a tracking light positioned on a side of the controller. The hole of the grip in the present disclosure enables the light to be tracked by a corresponding device (e.g., gaming console). In some embodiments, the at least one hole includes a fiber optic component or similar component for improving the transmission and tracking of a controller.

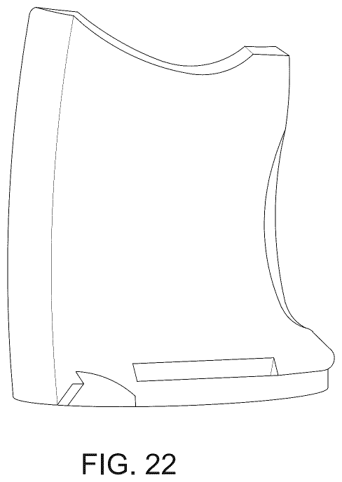

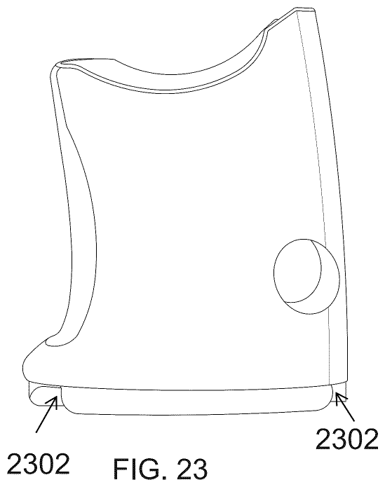

FIG. 22 illustrates a side view of a magnetic grip handle of a VR accessory according to an embodiment of the present disclosure. FIG. 23 illustrates a side view of a magnetic grip handle of a VR accessory according to an embodiment of the present disclosure. In some embodiments, as shown in FIG. 23, the magnetic grip receiver includes a plurality of grooves 2302 for creating a mechanical connection with a grip of a VR accessory. The plurality of grooves can be of varying designs for improving the mechanical connection to the grip, thereby improving the stability of the VR accessory during operation.

In some embodiments, the VR accessory can include a detachable grip. For example, and without limitation, the grip is detachable via a magnet, a clip, and other similar attachment mechanisms. The VR accessory can further include a spring-loaded telescopic shaft. For example, and without limitation, the VR accessory is operable to simulate a crossbow, a bolt-action rifle, and other similar weapons. Advantageously, this enables the VR accessory to simulate the pulling of a bowstring and similar weapons in a VR environment.

In some embodiments, the VR accessory further includes a garment operable to receive one or more components of the VR accessory. For example, and not limitation, the garment includes a vest designed to receive the forearm brace via an attachment mechanism (e.g., hook and loop mechanism, magnets, clips). Advantageously, a user can swap and/or add the forearm brace to the VR accessory when the front-end grip is being used. For further example and without limitation, in some embodiments, the VR accessory includes a garment attachment component (e.g., hook and loop strap) and a corresponding garment (e.g., belt). The VR accessory attaches to the corresponding garment via the garment attachment component. Advantageously, this enables users to simulate holstering and unholstering equipment.

In some embodiments, the VR accessory includes at least one marker (e.g., visual identifier, light emitting diode) that is detectable and trackable via a VR or AR system. Based on the at least one marker, the VR system is operable to determine a configuration of the VR accessory (e.g., front arm grip or forearm brace) and generate a corresponding VR weapon. The VR accessory is further operable for non-VR environments that require stability. For example, and not limitation, the VR accessory is usable for photography and is operable to receive a tripod.

For further example, and without limitation, in some embodiments, the VR accessory includes a plurality of identification components. The identification components can include motion sensors, optical sensors, light emitting diodes, radio frequency identification tags, near-field communication tags, and other similar identification technology. In some embodiments, the forearm brace, the front grip, the grip, the buttstock, and/or the adjustment sleeve includes an identification component. The VR accessory is operable for wired communication and/or wireless communication with a VR system. When a component (e.g., front grip) is attached to the VR accessory, the VR system is operable to detect a corresponding identification component. In response to identification of the corresponding identification component, the VR system is operable to automatically generate a VR weapon based on the attachment component. For example, and not limitation, the VR system is operable to automatically display a virtual shotgun when the VR system detects the front grip.

The VR system is further operable to track the motion of the VR system and to automatically update a corresponding VR environment, weapon, and/or character. For example, and without limitation, the VR system is operable to detect when the VR accessory moves from a downward angle to an upright position (e.g., aligned with a user's shoulder). In response, the VR system is operable to automatically aim down the sight of the virtual weapon. In yet another example, the VR system is operable to detect other motions including, but not limited to, holstering and unholstering a gun, pulling back on a bowstring, a pumping motion, and angling a weapon. In some embodiments, the VR system is operable to detect and monitor at least two VR accessories. For example, and not limitation, one VR accessory may include a forearm brace and a second VR accessory may include the front grip. The VR system, via at least one identification component, is operable to detect which VR accessory is being held and moved by a user. The VR system is further operable to similar dual welding when a user is holding each VR accessory in a separate hand.

In some embodiments, the VR accessory is usable for a virtual reality, augmented reality environment, mixed reality environments, hybrid reality, or a combination and/or derivatives thereof. For example, and without limitation, the virtual reality, augmented reality, and/or mixed reality environment includes action games, sports games, horror games, single-player games, multi-player games, first-person shooters, and other games compatible with virtual reality, augmented reality, mixed reality, and/or hybrid reality systems.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the present disclosure. The embodiment was chosen and described in order to best explain the principles of the present disclosure and the practical application, and to enable others of ordinary skill in the art to understand the present disclosure for various embodiments with various modifications as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for simulating a weapon comprising:
a brace;
a brace sleeve;
an adjustment mechanism;
a grip;
a hub;
a support beam member;
a support beam member sleeve;
a double jointed connector; and
an adjustable buttstock;
wherein the brace is adjustably connected to the brace sleeve;
wherein the brace is adjustably connected to the adjustment mechanism;
wherein the adjustment mechanism is connected to the hub;
wherein the hub is connected to the brace, support beam member, and the grip;
wherein the grip is operable to receive a gaming controller;
wherein the support beam member is adjustably connected to the support beam member sleeve;
wherein the support beam member is connected to the double jointed connector; and
wherein the double jointed connector is connected to the adjustable buttstock.

2. The device of claim 1, wherein the device is operable for use in virtual reality, augmented reality, mixed reality, and/or combinations thereof.

3. The device of claim 1, wherein the adjustable buttstock includes an adjustable height component and a cheek weld, wherein the adjustable height component is operable to raise and lower the cheek weld.

4. The device of claim 1, wherein the adjustment mechanism is operable for lateral and vertical angle adjustment of the brace.

5. The device of claim 1, wherein the hub connects to the grip at about midway of a height of the grip.

6. The device of claim 1, wherein the double jointed connector is operable for lateral movement of the adjustable buttstock.

7. The device of claim 1 further comprising an adjustable connector positioned between the double jointed connector and the adjustable buttstock, wherein the adjustable connector is operable to adjust a tilt position of the adjustable buttstock.

8. The device of claim 1, wherein the brace sleeve lengthens or shortens the brace.

9. The device of claim 1, wherein the support beam member sleeve lengthens or shortens the support beam member.

10. The device of claim 1 further comprising a controller handle including at least two magnets, wherein the grip further includes at least two magnets and at least one slot, wherein, via the at least two magnets and the at least one slot, the grip is operable to receive the controller handle.

11. A device for simulating a weapon, wherein the device comprises:
a front-end grip;
a front-end grip sleeve;
an adjustment mechanism;
a grip;
a hub;
a support beam member;
a support beam member sleeve;
a double jointed connector; and
an adjustable buttstock;
wherein the front-end grip is adjustably connected to the front-end grip sleeve;
wherein the front-end grip is adjustably connected to a mounting point on the grip;
wherein the hub is connected to the support beam member and the grip;
wherein the grip is operable to receive a gaming controller;
wherein the support beam member is adjustably connected to the support beam member sleeve;
wherein the support beam member is connected to the double jointed connector; and
wherein the double jointed connector is connected to the adjustable buttstock.

12. The device of claim 11, wherein the device is operable for use in virtual reality, augmented reality, mixed reality, and/or combinations thereof.

13. The device of claim 11, wherein the mounting point is positioned about midway of a height of the grip.

14. The device of claim 11, wherein the front-end grip sleeve lengthens or shortens the front-end grip.

15. The device of claim 11, wherein the support beam member sleeve lengthens or shortens the support beam member.

16. The device of claim 11, further comprising a controller handle including at least two magnets, wherein the grip includes at least two magnets and at least one slot, wherein, via the at least two magnets and the at least one slot the grip is operable to receive the controller handle.

17. The device of claim 11, wherein the grip includes a concave shape.

18. The device of claim 11 further comprising a paddle, wherein the paddle is adjustably connected to the grip.

19. The device of claim 11 further comprising an adjustable connector positioned between the double jointed connector and the adjustable buttstock, wherein the adjustable connector is operable to change a tilt position of the adjustable buttstock.

20. The device of claim 11, wherein the hub is further designed to receive a brace, wherein the brace is removably connected to the hub.
